(19) United States
(12) Patent Application Publication
(10) Pub. No.: US 2006/0179172 A1
(43) Pub. Date: Aug. 10, 2006

(54) Method and system for reducing power consumption of a direct memory access controller

(75) Inventors: Sivayya V. Ayinala, Plano, TX (US); Praveen K. Kolli, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/045,215

(22) Filed: Jan. 28, 2005

(51) Int. Cl. G06F 13/28

(52) U.S. Cl. 710/22

(57) ABSTRACT

A method and system for reducing the power consumption of a direct memory access (DMA) controller. A preferred method, for example, comprises: queuing a first DMA request in a queue; responding to the first queued DMA request when the computer system resources necessary for a DMA transfer are available; and placing at least some components of the computer system into a reduced power consumption state when the computer system resources necessary for the DMA transfer are not available.

### BACKGROUND

1. Technical Field

The present subject matter relates to direct memory access (DMA) controllers. More particularly, the subject matter relates to reducing the power consumption of a DMA controller.

2. Background Information

Microprocessor-based computer systems today are capable of moving large amounts of data, and DMA controllers are sometimes used to facilitate such transfers. These DMA controllers allow a system component, such as a microprocessor under software control, to specify a source and destination address within the system for the data to be transferred, and a byte or word count that determines how much data is transferred. The DMA controller may then transfer the data without further intervention by the system component, which may then perform other tasks in parallel with the transfer.

With the introduction of systems comprising multiple specialized microprocessors and intelligent components, each attempting to utilize a DMA controller, schedulers have been added to some DMA controllers to allow them to manage multiple independent requests for memory transfers. These schedulers place requests for memory transfers into one or more queues, ordering the requests in the queues using any of a variety of methods (e.g., first in/first out, last in/first out, and prioritized and arbitrated queues). When the resources necessary for a queued transfer request become available, a scheduler within the DMA controller executes the transfer. But scheduler queues may be continuously serviced as long as there are entries in the queues. Thus, a DMA scheduler may consume additional power servicing a queue while waiting for needed resources to become available for queued DMA transfers. This may not be desirable in systems where lowering power consumption is important.

### SUMMARY OF SOME OF THE PREFERRED EMBODIMENTS

Methods and systems are disclosed for reducing the power consumption of a direct memory access (DMA) controller. A preferred method, for example, comprises: queuing a first DMA request in a queue; responding to the first queued DMA request when the computer system resources necessary for a DMA transfer are available; and placing at least some components of the computer system into a reduced power consumption state when the computer system resources necessary for the DMA transfer are not available.

A preferred system comprises a first memory-mapped component, a DMA controller comprising a read scheduler and a memory, and a bus coupling the first memory-mapped component to the DMA controller. The read scheduler services a read request to transfer data from the first memory-mapped component to the memory. At least part of the read scheduler is placed into a hibernation state when no pending data transfer requests can be serviced. The hibernation state of the read scheduler causes the DMA controller to consume less power than that consumed when servicing a read request to transfer data. A preferred system may further comprise a second memory-mapped component coupled by the bus to the DMA controller, and the DMA controller further comprising a write scheduler. The write scheduler services a write request to transfer the data from the memory to the second memory-mapped component. At least part of the write scheduler is placed into the hibernation state when no pending write requests can be serviced, the hibernation state of the write scheduler causing the DMA controller to consume less power than that consumed when servicing the write request to transfer data.

A preferred DMA controller comprises a memory, a read port coupled to the memory and adapted to couple to a first device external to the DMA controller, and a transfer scheduler comprising a read port scheduler coupled to the read port. The read port scheduler performs a requested data read from the first external device and transfers data into the memory. The read port scheduler is placed into a sleep mode when no pending data reads can be performed. The sleep mode causes the DMA controller to consume less power than that consumed when attempting to perform the requested data read.

### BRIEF DESCRIPTION OF THE DRAWINGS

For a detailed description of the preferred embodiments of the invention, reference will now be made to the accompanying drawings in which:

FIG. 1 illustrates a computer system configured to incorporate several direct memory access (DMA) controllers constructed in accordance with at least some of the preferred embodiments;

FIG. 2 illustrates a block diagram of a DMA controller constructed in accordance with at least some of the preferred embodiments;

FIG. 3 illustrates a block diagram of a port channel scheduler configured for use within a DMA controller constructed in accordance with at least some of the preferred embodiments; and

FIG. 4 illustrates a state diagram of a method for reducing the power consumption of a port channel scheduler in accordance with at least some of the preferred embodiments.

### NOTATION AND NOMENCLATURE

Certain terms are used throughout the following discussion and claims to refer to particular system components. This document does not intend to distinguish between components that differ in name but not function.

In the following discussion and in the claims, the terms “including” and “comprising” are used in an open-ended fashion, and thus should be interpreted to mean “including but not limited to . . . . ” Also, the terms “couple,” “couples,” coupled, or any derivative thereof are intended to mean either an indirect or direct electrical connection. Thus, if a first device couples to a second device, that connection may be through a direct electrical connection, or through an indirect electrical connection via other devices and connections. Additionally, the term “system” refers to a collection of two or more parts and may be used to refer to a computer system or a portion of a computer system. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to suggest that the scope of the disclosure, including the claims, is limited to that embodiment.

Direct memory access (DMA) controllers may incorporate schedulers to manage multiple independent requests for memory transfers. These requests may originate from a variety of sources within a computer system, and the actual transfers may require any of a number of system components. If a resource required for a transfer is not available, the request may remain in a queue until it can be serviced at a later time. But while a request remains in the queue, the scheduler may consume power as it periodically checks the availability of resources needed for queued transfer requests. This power consumption may be reduced through the use of an event-driven scheduler capable of dropping into a “sleep” or “hibernation” state, and which “wakes up” into an “active” state only when an event occurs that indicates that it may be possible to perform a pending or newly queued transfer.

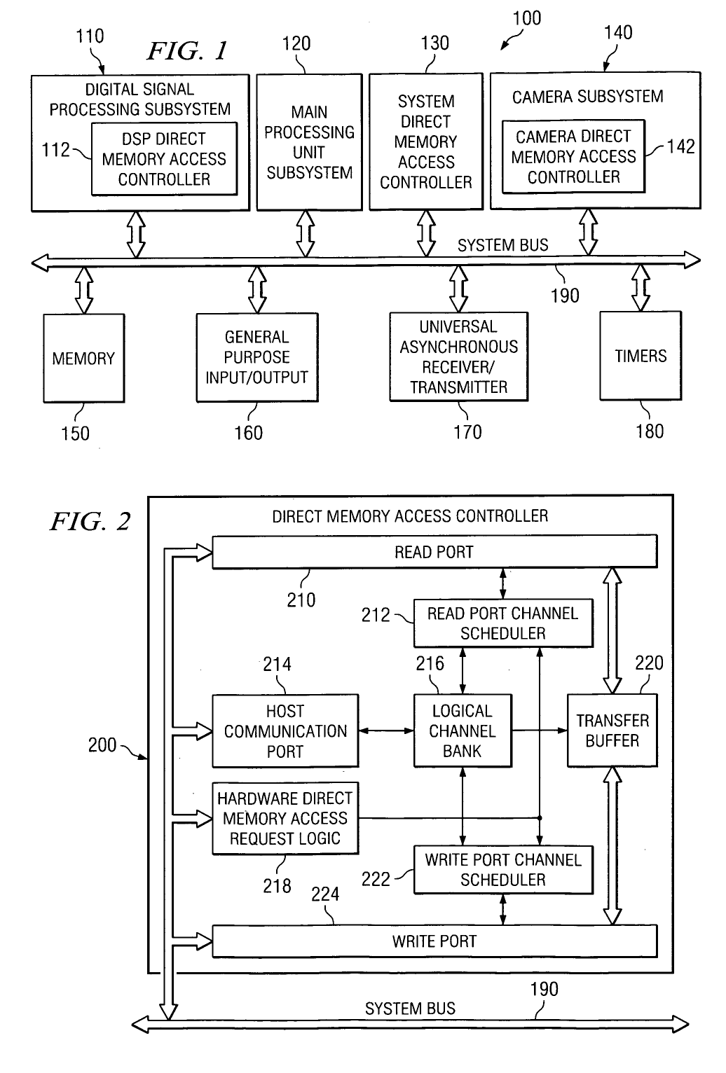

FIG. 1 illustrates a computer system 100 configured to incorporate several DMA controllers constructed in accordance with at least some of the preferred embodiments. System bus 190 couples the system components to each other as shown. These components may include a digital signal processing (DSP) subsystem 110 (comprising a DSP DMA controller 112), a main processing unit (MPU) subsystem 120, a system DMA controller (130), a camera subsystem 140 (comprising a camera DMA controller 142), memory 150, general-purpose input/output (GPIO) 160, a universal asynchronous receiver/transmitter (UART) 170, and timers 180. Each of the three DMA controllers within the example of the preferred embodiment shown may be used to perform transfers between any of the components within the system. Other preferred embodiments similar to that of FIG. 1 may include any number of DMA controllers, as well as a variety of system components that may include, but are not limited to, those illustrated in FIG. 1.

Software executing within any of the subsystems may setup and initiate a DMA transfer by one of the controllers. For example, a software program executing within MPU 120 may setup a DMA transfer of data received on a port within UART 170 to a range of locations within memory 150, using system DMA controller 130. The program may setup the address of the port within UART 170 as a source, the first location in memory 150 as a destination, and the byte or word count indicating the amount of data to be transferred. This configured transfer path, once setup, is sometimes referred to as a “channel.”

Once a channel is configured, a software program executing on a processor within the system may initiate a transfer by enabling the channel in the DMA controller. The DMA controller performs the requested transfer for the channel specified, as the source, destination, and intervening system bus 190 become available. The transfer may be performed as a single sequence of transferred data, or as smaller, separate transfers performed over time. The transfer in the example described may also be initiated directly by the UART 170, which may assert a dedicated DMA request signal within the system bus 190 that indicates to the DMA controller which channel to use for the transfer. Channels used for hardware DMAs may also be configured as described above for software-initiated DMAs. In at least some preferred embodiments the configuration of a hardware DMA transfer channel may be performed at system initialization.

FIG. 2 illustrates a DMA controller 200 constructed in accordance with at least some of the preferred embodiments. The system bus 190 couples to several components within the DMA controller 200, including the read port 210, the write port 224, the host communication port 214 and the hardware DMA request logic 218. The read port 210 reads data from a specified source coupled to the system bus 190, and the write port 224 writes data to a specified destination also coupled to the system bus 190. The read port 210 and the write port 224 both couple to transfer buffer 220. Transfer buffer 220 stores data read in through the read port 210 and written out through the write port 224. The read port 210 also couples to the read port channel scheduler 212, which manages the read portion of requested DMAs. Likewise, the write port 224 couples to the write port channel scheduler 222, which manages the write portion of requested DMAs.

Both the read port channel scheduler 212 and the write port channel scheduler 222 couple to both the hardware DMA request logic 218 and the logical channel bank 216. The hardware DMA request logic 218 sends a DMA channel number associated with a particular hardware DMA request signal as part of a hardware DMA request to the schedulers 212 and 222. The logical channel bank 216 provides a DMA channel number as part of a software DMA request to the schedulers 212 and 222. The host communication port 214 couples to the logical channel bank 216 and forwards software initiated DMA requests to the logical channel bank 216 for correlation to a specific, previously configured logical channel. The host communication port 214 may also be used to setup the channel configuration of the logical channel bank 216.

As already noted, a DMA request may be initiated by a hardware DMA request or a software DMA request. A hardware DMA request may be initiated directly by a hardware component within the system (e.g., UART 170), using any number of techniques (e.g., by asserting a DMA request signal on the system bus 190). The hardware request logic decodes the identifier of the hardware component requesting the DMA and sends a corresponding DMA channel as part of the DMA request sent to the channel schedulers 212 and 222. A software DMA request may be initiated by a program executing on a processor within the computer system 100 (e.g., a digital signal processor (not shown) within the DSP subsystem 110). The request is written into the host communication port 214 by the processor executing the software program requesting the DMA. The host communication port 214 forwards the request to the logical channel bank 216, which correlates a previously configured logical channel number to the request. The channel number is then sent to the channel schedulers 212 and 222 as part of the DMA request.

When a DMA request is initiated (either by hardware or software), the request is split into separate read and write requests. The read port channel scheduler handles the read request, and the write port channel scheduler handles the write request. In this way it is not necessary for both the source and destination system resources to be available at the same time in order to perform a transfer. Instead, only one needs to be available, in addition to any required internal resources (e.g., transfer buffer 220). Each portion of the transfer may execute with relative independence from the other.

In addition, multiple DMA transfer requests may overlap with each other. Depending on the configuration of the schedulers 212 and 222, any number of read and write transfers may be in progress. This is because the data for a given DMA transfer may not be transferred all at once in one large block, but instead may be broken into several smaller blocks, each transferred as the availability of resources permit. This allows many of these smaller groups of blocks, each from multiple independent DMA transfers, to be interleaved with each other. Each of these “active” DMA transfers is sometimes referred to as a “thread.” Additionally, the number of write transfers allowed to be in progress at one time (i.e., active write threads) does not necessarily have to be the same as the number of read transfers in progress (i.e., active read threads). Thus, for example, one preferred embodiment may comprise a read port channel scheduler 212 that supports up to 4 active read threads, and a write port channel scheduler 222 that supports up to 2 active threads. Other preferred embodiments may support any number of active threads in each scheduler, and it is intended that the present disclosure encompass all such variations.

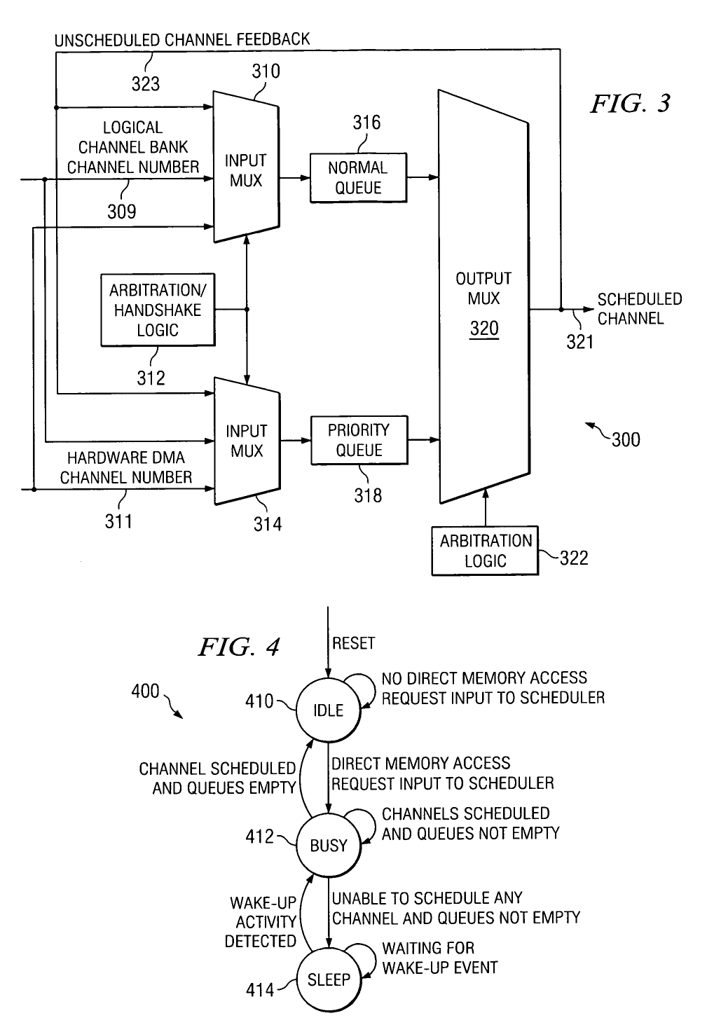

FIG. 3 illustrates a channel scheduler 300 constructed in accordance with at least some preferred embodiments, and adaptable for use as both a read port channel scheduler (e.g., read port channel scheduler 212) and a write port channel scheduler (e.g., write port channel scheduler 222). The channel scheduler 300 shown comprises two queues, a normal queue 316 and a priority queue 318. Each queue may be supplied with a channel number selected by a 3-to-1 input multiplexer (input MUX). Input multiplexer 310 may provide a channel number to the normal queue 316, and input multiplexer 314 may provide a channel number to the priority queue 318.

Each of the input multiplexers has as an input a hardware DMA channel number (HW DMA Ch Num) 311, a logical channel bank or software DMA channel number (LCB Ch Num) 309, and unscheduled channel feedback 323 (scheduled channel 321 provided as a store-back channel number from the output of output multiplexer (output MUX) 320 when the channel cannot be scheduled). The selection of one of the three inputs is controlled by arbitration/handshake logic 312, which may implement any of a variety of priority schemes (e.g., hardware DMA channels may always have priority over software DMA channels, both of which may always have priority over store-back channels).

The output of each queue is input to output multiplexer 320, and arbitration logic 322 determines which queue output becomes the scheduled channel. The determination is made based on the priority scheme implemented. In some preferred embodiments, for example, an interleaved, round-robin priority scheme may be implemented, wherein the normal queue may be serviced, and a pending normal request output as a scheduled channel by the output multiplexer 322, once for every four priority queue requests serviced, regardless of the number of pending requests in the priority queue. The ratio of requests scheduled between the normal and priority queue may be configurable by loading a value into a configuration register (not shown) within the arbitration logic 322.

Channel scheduler 300, in accordance with at least some preferred embodiments, may be configured such that if all of the entries in both the normal queue and the priority queues have been processed, and none of the entries currently may be serviced, the channel scheduler 300 may enter into a hibernation state where it does no further checking for available resources. While in this hibernation state, power consumption by the channel scheduler 300 is reduced. In such a “hibernation” or “reduced power consumption” state the scheduler may be placed into an idle mode, or may be disabled to some degree, thus reducing the overall power consumed by the scheduler when compared to the power consumed by the scheduler when in the “active” state.

The channel scheduler 300 may wake-up from this hibernation state if one or more predefined events or sequences of events occur. Such events may include receipt of a new DMA request, a free thread becoming available, buffer space becoming available in the transfer buffer 220 (FIG. 2), and the system bus 190 becoming available (i.e., not in a busy state). Other events may also represent an appropriate rationale for waking up the channel scheduler 300 in accordance with at least some preferred embodiments, and it is intended that the present disclosure encompass such events and criteria.

FIG. 4 illustrates a state diagram for a method 400 for implementing a reduced power consumption mode of operation for a channel scheduler constructed in accordance with at least some preferred embodiments. This reduced power consumption mode of operation may be achieved by placing the channel scheduler in either an idle state, or a sleep or hibernation state, as described below. After completion of a system reset, the channel scheduler enters the idle state 410, remaining in that state as long as no DMA request is input to the scheduler. Upon receipt of a DMA request, the channel scheduler enters busy state 412. While in busy state 412 the channel scheduler will check the DMA queues for requests that can be serviced. The channel scheduler will continue to schedule channels for data transfers as long as at least one request in the queues can be serviced, the queues are not empty, and any other conditions required for scheduling exist.

If while in busy state 412 the channel scheduler attempts to schedule each of the entries in each of the queues and fails to schedule at least one channel, the channel scheduler transitions from busy state 412 to sleep state 414. The channel scheduler, once in sleep state 414, will not perform any further attempts at scheduling a channel. The channel scheduler will remain in the sleep state 414 until one or more predefined “wake-up” events occur that cause the channel scheduler to wake-up and transition back to the busy state 412. Once back in the busy state 412, processing of queue entries resumes until the channel scheduler again fails to schedule at least one channel (and again transitions into sleep state 414), or until all queued DMA requests are completed. Once all DMA requests are completed (leaving the queues empty) the channel scheduler transitions back to idle state 410 and waits for a new DMA request.

It should be noted that although the preferred embodiments described and illustrated comprise a channel scheduler with both normal and priority queues, other preferred embodiments may include additional or fewer queues. Thus, in some preferred embodiments, each channel scheduler may comprise only a single queue, while in other preferred embodiments each channel scheduler may comprise three or more queues. It is intended that the present disclosure encompass all such variations.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method used in a computer system, comprising:
queuing a first direct memory access (DMA) request in a queue;
responding to the first queued DMA request when computer system resources necessary for a DMA transfer are available; and
placing at least some components of the computer system into a reduced power consumption state when the computer system resources necessary for the DMA transfer are not available.

2. The method of claim 1, further comprising taking the at least some components of the computer system out of the reduced power consumption state when an event within the computer system occurs.

3. The method of claim 2, wherein the event within the computer system comprises a source resource becoming available.

4. The method of claim 2, wherein the event within the computer system comprises a destination resource becoming available.

5. The method of claim 2, wherein the event within the computer system comprises a bus within the computer system transitioning to an idle state.

6. The method of claim 2, wherein the event within the computer system comprises adding a second DMA request to the queue.

7. A computer system, comprising:
a first memory-mapped component;
a direct memory access (DMA) controller comprising a read scheduler and a memory; and
a bus coupling the first memory-mapped component to the DMA controller;
wherein the read scheduler services a read request to transfer data from the first memory-mapped component to the memory; and
wherein at least part of the read scheduler is placed into a hibernation state when no pending read requests can be serviced, the hibernation state of the read scheduler causing the DMA controller to consume less power than that consumed when servicing the read request to transfer data.

8. The computer system of claim 7, wherein the at least part of the read scheduler is taken out of the hibernation state when a state change of the computer system indicates that at least one pending read request may be serviceable.

9. The method of claim 8, wherein the state change of the computer system comprises a state indicating that the first memory-mapped component has become available.

10. The method of claim 8, wherein the state change of the computer system comprises a state indicating that the bus has transitioned to an idle state.

11. The method of claim 8, wherein the state change of the computer system comprises a state indicating that a new read request is available for processing by the read scheduler.

12. The computer system of claim 7, further comprising:
a second memory-mapped component coupled by the bus to the DMA controller; and
the DMA controller further comprising a write scheduler;
wherein the write scheduler services a write request to transfer the data from the memory to the second memory-mapped component; and
wherein at least part of the write scheduler is placed into the hibernation state when no pending write requests can be serviced, the hibernation state of the write scheduler causing the DMA controller to consume less power than that consumed when servicing the write request to transfer data.

13. The computer system of claim 12, wherein the at least part of the write scheduler is taken out of the hibernation state when the state change of the computer system indicates that at least one pending write request may be serviceable.

14. The method of claim 13, wherein the state change of the computer system comprises a state that indicates that the second memory-mapped component has become available.

15. The method of claim 13, wherein the state change of the computer system comprises a state indicating that a new write request is available for processing by the write scheduler.

16. A direct memory access (DMA) controller, comprising:
a memory;
a read port coupled to the memory and adapted to couple to a first device external to the DMA controller; and
a read port scheduler coupled to the read port;
wherein the read port scheduler performs a requested data read from the first external device and transfers data into the memory; and
wherein the read port scheduler is placed into a sleep mode when no pending data reads can be performed, the sleep mode causing the DMA controller to consume less power than that consumed when attempting to perform the requested data read.

17. The DMA controller of claim 16, wherein the read port scheduler is taken out of the sleep mode when at least one pending data read can be performed.

18. The DMA controller of claim 16, further comprising:
a write port coupled to the memory and adapted to couple to a second device external to the DMA controller; and
a write port scheduler coupled to the write port;
wherein the write port scheduler further performs a requested data write of the data into the second external device, the data having been read from the memory; and
wherein the write port scheduler is placed into the sleep mode when no pending data writes can be performed, the sleep mode causing the DMA controller to consume less power than that consumed when attempting to perform the requested data write.

19. The DMA controller of claim 18, wherein the write port scheduler is taken out of the sleep mode when at least one pending data write can be performed.
